(19) United States
(12) Patent Application Publication
(10) Pub. No.: US 2018/0032170 A1
(43) Pub. Date: Feb. 1, 2018

(54) SYSTEM AND METHOD FOR ESTIMATING LOCATION OF A TOUCH OBJECT IN A CAPACITIVE TOUCH PANEL

(71) Applicant: SAMSUNG ELECTRONICS CO., LTD., Suwon-si (KR)

(72) Inventors: Karimulla SHAIK, Andhra Pradesh (IN); Sandeep VANGA, Bangalore (IN); Prathyusha VADREVU, Vijayawada (IN); Jongseon KIM, Seongnam-si (KR); Seungjae LEE, Suwon-si (KR)

(73) Assignee: SAMSUNG ELECTRONICS CO., LTD., Suwon-si (KR)

(21) Appl. No.: 15/220,621

(22) Filed: Jul. 27, 2016

(51) Int. Cl. G06F 3/044; G06F 3/041

(52) U.S. Cl. CPC G06F 3/044; G06F 3/0418; G06F 2203/04101

(57) ABSTRACT

A method and capacitive touch panel are provided. The method includes receiving, by a sensing circuit, raw data for detecting a touch object in a proximity of a capacitive touch panel, where the raw data includes a difference of a mutual capacitance value and a self-capacitance value at each of touch nodes of the capacitive touch panel; processing, by a touch sensing controller, the received raw data to derive digitized capacitance data; classifying, by the touch sensing controller, the digitized capacitance data; and estimating, by the touch sensing controller, at least one of a location of the touch object on the capacitive touch panel and a distance of the touch object from the capacitive touch panel within the proximity using the classified capacitance data.

### FIELD

Methods and systems consistent with the present disclosure relate to an electronic device with capacitive touch interface and, more particularly, to a system and method for precisely extracting three dimensional locations of a touch object in a proximity of a capacitive touch interface of the electronic device.

### BACKGROUND

With more and more emphasis being laid on simple and intuitive user interfaces, many new techniques for interacting with electronics devices are being developed. Most of the electronic devices including, but not limited to, mobile phones, laptops, personal digital assistants (PDAs), tablets, cameras, televisions (TVs), other embedded devices, and the like are being used with touch screen interfaces because of their ease of use. Various 3D air-gestures like flick, waving, circling fingers etc., can be used for interacting with a wide variety of applications to implement features such as interactive zoom in/out of a display, image editing, pick and drop, thumbnail display, movement of cursors, etc. Particularly for high end applications like gaming, painting etc., it is advantageous to determine an exact three-dimensional (3D) location of a pointing object, such as a finger or stylus, on the touch screen interfaces.

### SUMMARY

According to an aspect of an exemplary embodiment, there is provided a method for estimating location of a touch object in a capacitive touch panel, the method comprising receiving, by a sensing circuit, raw data for detecting a touch object in a proximity of the capacitive touch panel, the raw data comprising a difference of a mutual capacitance value and a self-capacitance value at each of a plurality of touch nodes of the capacitive touch panel; processing, by a touch sensing controller, the received raw data to derive digitized capacitance data; classifying, by the touch sensing controller, the digitized capacitance data; and estimating, by the touch sensing controller, at least one of a location of the touch object on the capacitive touch panel and a distance of the touch object from the capacitive touch panel within the proximity using the classified capacitance data.

The processing may comprise filtering noise data from the raw data to obtain threshold digitized capacitance data; and extracting one or more features from the threshold digitized capacitance data, the one or more features including an energy, a gradient, a peak and a flatness aspect associated with the threshold digitized capacitance data.

The location of the touch object may be estimated by determining an X coordinate and a Y coordinate of the location of the touch object on the capacitive touch panel.

The distance of the touch object from the capacitive touch panel may be estimated based on at least one of an offline mode and an online mode.

The offline mode may comprise a linear discriminant analysis (LDA) and a Gaussian mixture model (GMM).

The online mode may comprise estimating the distance of the touch object based on extracted features.

The method may further comprise learning discriminant functions using extracted features, and storing cluster centers for the linear discriminant analysis (LDA) during the offline mode.

The method may further comprise learning covariance matrices and mixture weights of the Gaussian Mixture Model (GMM) using extracted features obtained in the offline mode.

The method may further comprise inputting features extracted during an offline mode to a classifier; projecting the extracted features onto a new coordinate system using vectors obtained during an online mode; determining distances from each of a plurality of cluster centers to the projected features in the new coordinate system; and assigning a vector with a class label having a minimum distance from the capacitive touch panel.

According to another aspect of an exemplary embodiment, there is provided a capacitive touch panel for estimating location of a touch object relative to the capacitive touch panel, the capacitive touch panel comprising a sensor circuit that receives raw capacitance data for detecting a touch object in a proximity of the capacitive touch panel, the raw data comprising a difference of a mutual capacitance value and a self-capacitance value at each of a plurality of touch nodes of the capacitive touch panel; and at least one microprocessor configured to process the received raw data to derive digitized capacitance data; extract a plurality of features from the digitized capacitance data; the plurality of features comprising an energy, a gradient and class labels; project the extracted features on to a new coordinate system using vectors obtained during an online phase; classify the digitized capacitance data; determine distances from each of a plurality of cluster centers to the projected features in the new coordinate system; assign a vector with a class label having a minimum distance from the capacitive touch panel; and estimate at least one of a location of the touch object on the capacitive touch panel and a distance of the touch object from the capacitive touch panel within the proximity using the classified capacitance data.

According to yet another aspect of an exemplary embodiment, there is provided a capacitive touch panel comprising a plurality of sensor electrodes configured to detect a touch object in proximity to the sensor electrodes using capacitance, and to generate raw capacitance data; and at least one microprocessor configured to, in a training phase, digitize training capacitance data from the sensor electrodes to generate training capacitance data, extract one or more features from the training capacitance data, classify the extracted one or more features to generate first classified data, and estimate a height of the touch object from the capacitive touch panel using the first classified data; and, in a testing phase, digitize test capacitance data from the sensor electrodes to generate test capacitance data, extract one or more features from the test capacitance data, classify the extracted one or more features based on the first classified data to generate second classified data, and determine the height of the touch object from the capacitive touch panel using the second classified data, the one or more extracted features from the test capacitance data, and the estimated height.

The capacitive touch panel may further comprise an analog front end that removes noise from the raw capacitance data and digitizes the raw capacitance data.

The features may comprise an energy, a gradient, a peak, and a flatness.

The extracted one or more features may be classified to generate the first classified data in the training phase using a linear discriminant analysis (LDA) and/or a Gaussian mixture model (GMM), and the extracted one or more features may be classified to generate the second classified data in the testing phase using a linear discriminant analysis (LDA) and/or a Gaussian mixture model (GMM).

The first classified data may comprise one or more basis vectors and one or more cluster centers in a new coordinate system that is different from a coordinate system of the raw capacitance data.

In the testing phase, the one or more extracted features may be projected onto a new coordinate system using the basis vectors.

The at least one microprocessor may determine an X coordinate and a Y coordinate of the touch object on the capacitive touch panel.

The height may be determined as a Z coordinate.

### BRIEF DESCRIPTION OF THE DRAWINGS

The above and other aspects will occur to those skilled in the art from the following description and the accompanying drawings in which:

FIG. 1 is a schematic diagram illustrating a capacitive touch panel represented by grids of transmitter and receiver electrodes and formation of the mutual capacitance at the intersections, according to the related art;

FIG. 2 is a schematic diagram illustrating a capacitance based touch screen and a Touch Sensor Pattern (TSP), according to an exemplary embodiment;

FIG. 3 is a schematic block diagram of a system for performing three-dimensional (3D) location estimation of a touch object from a touch panel, according to an exemplary embodiment;

FIG. 4 is a schematic block diagram illustrating a two staged height estimation of a touch object in proximity of a capacitive touch panel, according to an exemplary embodiment;

FIG. 5 is a flow chart illustrating a method of performing a height estimation of a touch object within a proximity of a touch screen, according to an exemplary embodiment ;

FIG. 6 is a flow chart illustrating a method of performing Linear Discriminant Analysis (LDA) based height estimation of a touch object from a touch panel within a proximity of a touch screen, according to an exemplary embodiment;

FIG. 7 is a flow chart illustrating a method of performing Gaussian Mixture Model (GMM) or Multi Gaussian Model (MGM) based height estimation of a touch object from a touch panel within a proximity of a touch screen, according to an exemplary embodiment; and

FIG. 8 is a flow chart illustrating a method of performing a finer level height estimation based on a transfer function based regression approach, according to an exemplary embodiment.

### DETAILED DESCRIPTION

In the following detailed description of exemplary embodiments, reference is made to the accompanying drawings that form a part hereof, and in which are shown by way of illustration specific exemplary embodiments in which the present inventive concept may be practiced. Although specific features are shown in some drawings and not in others, this is done for convenience only as each feature may be combined with any or all of the other features.

These exemplary embodiments are described in sufficient detail to enable those skilled in the art to practice the present inventive concept, and it is to be understood that other exemplary embodiments may be utilized and that changes may be made without departing from the scope of the claims. The following detailed description is, therefore, not to be taken in a limiting sense, and the scope is defined only by the appended claims.

The specification may refer to “an”, “one” or “some” exemplary embodiment(s) in several locations. This does not necessarily imply that each such reference is to the same exemplary embodiment(s), or that the feature only applies to a single exemplary embodiment. Single features of different exemplary embodiments may also be combined to provide other exemplary embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features, integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The exemplary embodiments herein and the various features and advantages details thereof are explained more fully with reference to the non-limiting embodiments that are illustrated in the accompanying drawings and detailed in the following description. Descriptions of well-known components and processing techniques are omitted so as to not unnecessarily obscure the exemplary embodiments herein. The examples used herein are intended merely to facilitate an understanding of ways in which the exemplary embodiments herein can be practiced and to further enable those of skill in the art to practice the exemplary embodiments herein. Accordingly, the examples should not be construed as limiting the scope of the exemplary embodiments herein.

Among the various types of touch technologies, capacitive touch sensing is gaining popularity due to its reliability, ease of implementation and capability to handle multi-touch inputs. Capacitive touch sensing can be achieved by either measuring a change in self-capacitance or a change in mutual capacitance.

Mutual capacitance based touch panels have different patterns of sensor electrodes. One of the most common electrode patterns is called a diamond pattern. In a diamond pattern, both horizontal and vertical electrodes are overlaid on top of each other to cover an entire display region. Nodes of intersections between horizontal and vertical electrodes form mutual capacitance. In the presence of an external conducting object, the mutual capacitance value drops from the normal value (i.e., the capacitance value when not in the presence of an external conducting object. The amount of change in mutual capacitance is different at different nodes.

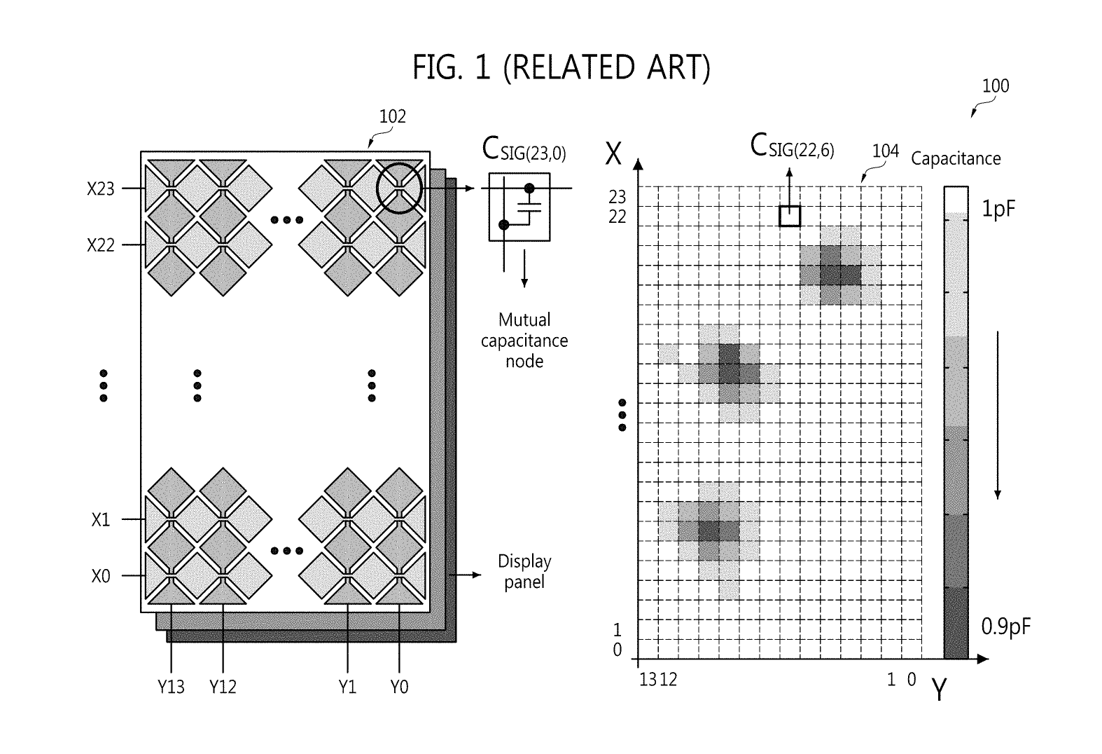

FIG. 1 is a schematic diagram 100 illustrating a capacitive touch panel represented by grids of transmitter and receiver electrodes and formation of the mutual capacitance at the intersections, according to the related art. According to the FIG. 1, the capacitive touch panel 102 comprises transmitter and receiver electrodes. When the transmitter electrodes are excited with a voltage pulse, the charge accumulated at the electrodes can be collected at the receiving end and in turn capacitance is measured. Similarly at all Y0 to Y13, the capacitance data is measured for each transmitter channel excitation, and the so-called ambient capacitance data or untouched capacitance data is obtained at each node.

When a touch object such as finger or stylus (not shown in FIG. 1) interacts with the touch panel 102, the mutual capacitance data in that region of panel is decreased from the ambient capacitance level. Also, the decrease in mutual capacitance values is more at the center of the touch object and gradually reduces towards the boundaries of the touch object. Additionally, an amount of the decrease in mutual capacitance is more when a center of the touch object is aligned with an electrode. Therefore, a “difference mutual capacitance” which is the difference between the ambient (no touch) and touch capacitance data gives information about the region of the touch. The difference mutual capacitance values decrease in radial fashion from a center of the touch towards the boundary of the touch object.

Further, schematic diagram 100 illustrates formation of a mutual capacitance in the touch panel 104. According to the schematic diagram 100, the touch panel 104 shows three different instances of “mutual capacitance data” on the touch panel. On a grey-scale ranging from complete black to complete white, the darker the color, the lower the capacitance. Thus, a light grey indicates higher capacitance and a dark grey indicates lower capacitance. By looking at the capacitance data shown in grids, it can be observed that wherever a touch happens on the touch panel, the capacitance value reduces in a particular fashion, which is imprinted with darkest color at the center and gradually moves towards a whiter color as the distance increases from the center of the touch.

The same pattern for mutual capacitance can be used for self-capacitance also. Self-capacitance is formed between any touch object and the electrodes, wherein the touch object may be of any conductive material such as a finger or a stylus and wherein the touch object is held a certain height above the touch panel. A sensing circuit measures the overlapped capacitance between a sensing line (electrodes) and the touch object. In the absence of a touch object, ambient self-capacitance data, also called untouched Self Capacitance Data, is obtained at each sensing line. If the touch object is held in proximity to the touch panel, the self-capacitance data in that corresponding region of the panel will be increased from the ambient capacitance level. Thus, a difference capacitance which is a difference between the ambient capacitance data and the proximity capacitance data gives a sense about the region and height of the touch object.

As the number (i.e., the density) of electrodes in the capacitive touch panel increases, the sensitivity of the touch screen also changes. However, there is a practical limitation to the density of electrodes. In case of self-capacitance touch panels, a very small number of nodes are obtained per frame (typically with grid size of 30×17), and very few of the nodes are affected by the touch object.

Further, there exists many unavoidable ambient noise sources which affect the quality of the capacitance data. To reduce the display panel thickness, the touch sensors are placed very close to the display driving lines. This technology is referred to as on-cell capacitive sensing. In on-cell capacitive touch panels, a main disadvantage faced is display noise in touch signals due to the cross-coupling between the display lines and the touch sensors. Though some kind of noise removal techniques are employed, it is impossible to completely eliminate such noise. Additionally, there are many other noise sources like charger noise, environmental noise from environmental changes and the like.

Further, in case of self-capacitance data, to improve the sensitivity of the sensor, an area of the conductors is increased by grouping multiple driving and sensing lines together and in turn both a signal to noise ratio (SNR) and a sensitivity of the sensory data increases at the cost of resolution. Therefore, as the capability of the sensor to respond to touch objects at higher heights increases, the cost of resolution, i.e., the number of nodes/electrodes per frame, decreases.

Though there are many existing algorithms supporting detection of proximity, estimating a level of proximity precisely is still a major challenge in the context of touch interfaces. In view of the foregoing, there is a need of an improved classifier-regression based approach which can be used with capacitive touch sensing technology and which addresses the above explained challenges efficiently. Further, there is a need for a system and method for precisely extracting three dimensional locations of a touch object in the proximity of the capacitive touch interface built in to an electronic device.

The exemplary embodiments provide a system and method for estimating a location of a touch object in a capacitive touch panel.

According to an exemplary embodiment, a system and method for estimating a location of a touch object in a capacitive touch panel is described herein. The exemplary embodiments may enable users to perform various operations on a touch panel of a touch screen device, by bringing a touch object within a proximity of the touch panel and thereby the touch screen panel can identify the touch object. According to an exemplary embodiment, the touch object may be at least one of, but is not limited to, a stylus or one or more fingers of a user, and the like. One of ordinarily skill in the art will understand that many different types of touch objects may be used and detected, and a location of the touch object can be estimated by the methods disclosed herein.

According to an exemplary embodiment, a method for estimating a location of a touch object in a capacitive touch panel may be provided. The method may include receiving, by a sensing circuit, raw data on identifying a touch object in a proximity of the capacitive touch panel. The proximity may be predetermined. A touch screen device may include the capacitive touch panel (herein after called a “touch panel”), wherein the touch panel further comprises a sensing circuit. Whenever the touch object is brought within the proximity of the capacitive touch panel, the sensing circuit may identify the presence of the touch object and may receive the raw data . According to an exemplary embodiment, the raw data may comprise a mutual capacitance value and a self-capacitance value at each touch node of the capacitive touch panel.

Further, the method may include processing the received raw data to derive a digitized capacitance data. The received raw data may be further provided to an analog front end (AFE) circuit that receives the raw capacitance data of the touch object and converts the analog data into digitized capacitance data. In an exemplary embodiment, the AFE circuit also may suppress noise generated by various sources, from the digitized capacitance data to provide noise free data.

According to an exemplary embodiment, processing the received raw data may comprise filtering noisy data from the raw data to obtain a threshold digitized capacitance data. Based on the received raw data, the digitized capacitance data may be obtained and further noise may be filtered by the AFE. From the noiseless digitized raw data, a threshold digitized capacitance data may be obtained. Processing the received raw data may further include extracting one or more features from the digitized capacitance data, where the one or more features includes, but is not limited to, an energy, a gradient, a peak, a flatness aspect, and the like, associated with the capacitance data

Further, the method may include classifying the digitized capacitance data. The digitized capacitance data may be provided to a feature extraction module that identifies and extracts features from the digitized capacitance data. Further, based on the identified features, a classifier module/classification module may identify the classes in the digitized capacitance data.

Further, the method may include estimating, by a touch sensing controller, at least one of a location of the object on the capacitive touch panel and a distance of the touch object from the capacitive touch panel within the proximity using the classified capacitance data. Based on the identified classes in the digitized capacitance data, the touch sensing controller may estimate at least one of a location of the object on the capacitive touch panel and a distance of the touch object from the capacitive touch panel within the proximity using the classified capacitance data.

According to an exemplary embodiment, estimating the location of the object on the capacitive touch panel may include determining an X coordinate and a Y coordinate of the location of the touch object on the capacitive touch panel.

In an exemplary embodiment, the distance of the touch object from the touch panel within the proximity may include an offline mode (i.e., a testing phase) and an online mode (i.e., a training phase). In the online mode the attributes of a classifier such as linear discriminant analysis (LDA) or Gaussian mixture models (GMM) may be derived. and during the online mode the attributes/parameters may be used to estimate the distance of the touch object based on the extracted features.

In an exemplary embodiment, the linear discriminant analysis (LDA) may include learning discriminant functions using the extracted features and storing cluster centers during the offline mode.

In another exemplary embodiment, Gaussian Mixture Model (GMM) may include learning covariance matrices and mixture weights of Gaussian Mixture Model (GMM) using the features obtained in the offline mode.

According to an exemplary embodiment, the method for estimating the location of a touch object in a capacitive touch panel, during the offline mode, may further include inputting the features extracted during the offline phase to a classifier. Further, the method may include projecting the extracted features on to a new coordinate system using vectors obtained during the online phase. Further, the method may include determining distances from each cluster center to the projected values in the new coordinate system. Further, the method may include assigning the vector with a class label having a minimum distance from the capacitive touch panel.

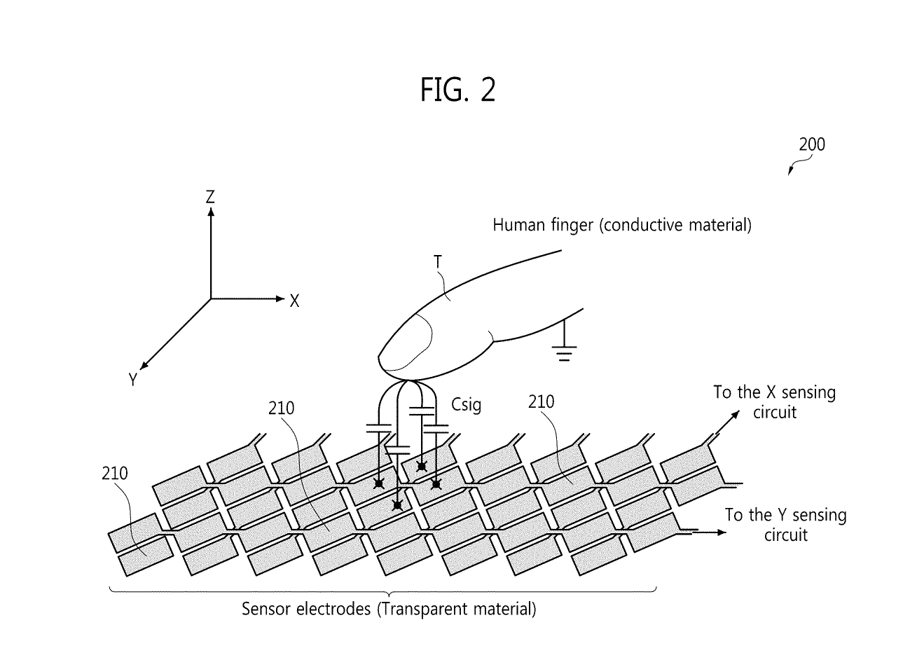

FIG. 2 is a schematic diagram 200 illustrating a capacitance based touch screen and a Touch Sensor Pattern (TSP) of the capacitance based touch screen, according to an exemplary embodiment. The touch sensor pattern (TSP) of the capacitance based touch screen, shown in FIG. 2, may be used for self-capacitance as well as mutual capacitance, based on the source signal. For instance, considering a self-capacitance mode, in schematic diagram 200, self-capacitance is formed between sensor electrodes 210 and a touch object T that is held a certain height above touch panel. The certain height may be predetermined, and may be set based on experimental data. As shown in FIG. 2, the touch object T may be a finger. However, the touch object may be a stylus or other object that is commonly used for touching touch panels. A sensing circuit of the touch panel measures the overlapped capacitance between a sensing line of the sensor electrodes 210 and the touch object T. A sensing line denotes a line of sensing electrodes in the X or Y direction. For example, FIG. 2 shows two sensing lines in the Y direction and eight sensing lines in the X direction. However, this is only an example, and the number of sensing lines in each direction may be greater or less than these numbers of sensing lines. In the absence of the touch object, the ambient self-capacitance data (i.e., Untouched Self Capacitance Data) is obtained at each sensing line. If the touch object is held in proximity to the touch panel, the self-capacitance data in that corresponding region of the touch panel may be increased from an ambient capacitance level. Thus, a difference capacitance which is a difference between the ambient capacitance data and proximity capacitance data gives a sense about the region and height of the touch object from the touch panel.

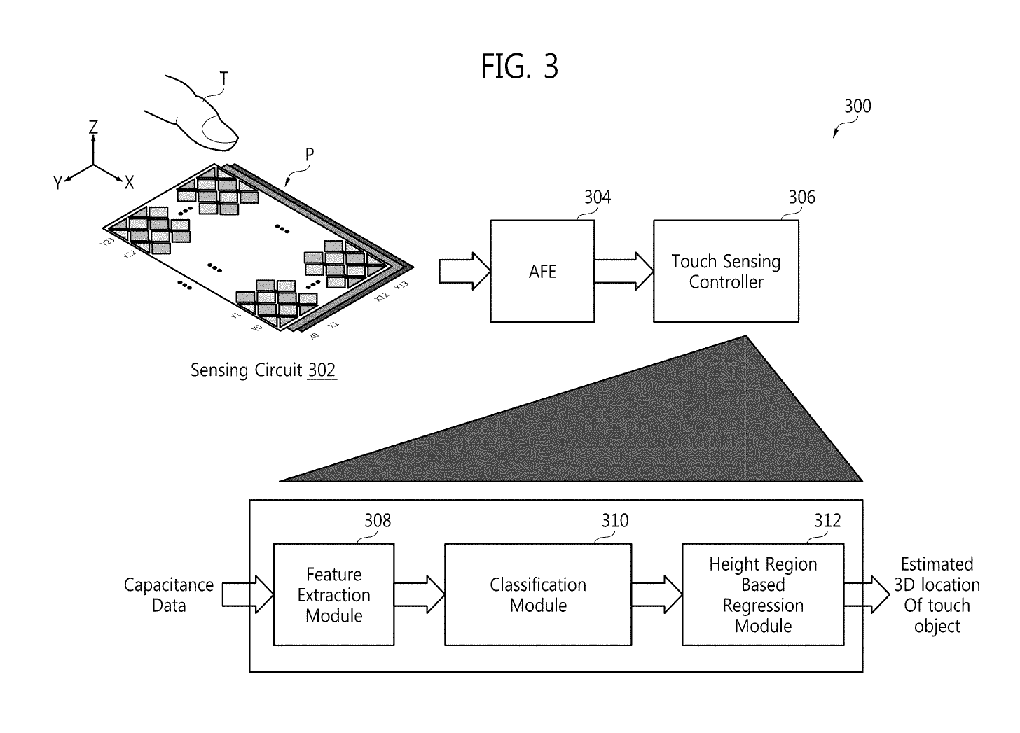

FIG. 3 is a schematic block diagram of a system 300 for performing a 3D location estimation of a touch object from a touch panel, according to an exemplary embodiment. According to the block diagram, a touch object T such as a finger comes within a proximity of a touch panel P, and a sensing circuit 302 of the touch panel P senses the touch object T and receives raw capacitance data. The obtained raw capacitance data is provided to an analog front end (AFE) 304 that converts the raw capacitance data into digitized data (i.e., digitized capacitance data). Further, the AFE 304 filters out noise from the digitized capacitance data. The digitized capacitance data may be further provided to a touch sensing controller 306.

The touch sensing controller 306 comprises a feature extraction module 308, a classification module 310, and a height region based regression module 312. The touch sensing controller 306 may be implemented by one or more microprocessors. The feature extraction module 308 of the touch sensing controller 306 receives the digitized capacitance data and extracts one or more features from the digitized capacitance data. Further, the extracted features may be provided to the classification module 310. The classification module 310 identifies classes of the digitized capacitance data. The classification module 310 may work both in an offline mode and an online mode. The offline mode denotes a mode in which a touch object is not within a proximity of the touch screen, whereas an online mode denotes a mode in which a touch object is within a proximity of the touch screen. During the offline mode, the classification module 310 may use linear discriminant analysis (LDA) or Gaussian mixture models (GMM) models to identify the classes of the digitized capacitance data. One having ordinarily skill in the art will understand that alternatively any of other known model may be used to obtain classes of the digitized capacitance data.

Upon identifying classes of the capacitance data, the height region based regression module 312 determines a height of the touch object T from the touch panel P based on the identified classes. The classification module 310 identifies the classes, which indicates the height of the touch object T from the touch panel P in Z coordinate at a coarse level. The height region based regression module 312 determines the distance of the touch object T from the touch panel P at finer level (in 3-dimension). The height region based regression module 312 may use a two staged height estimation as described below.

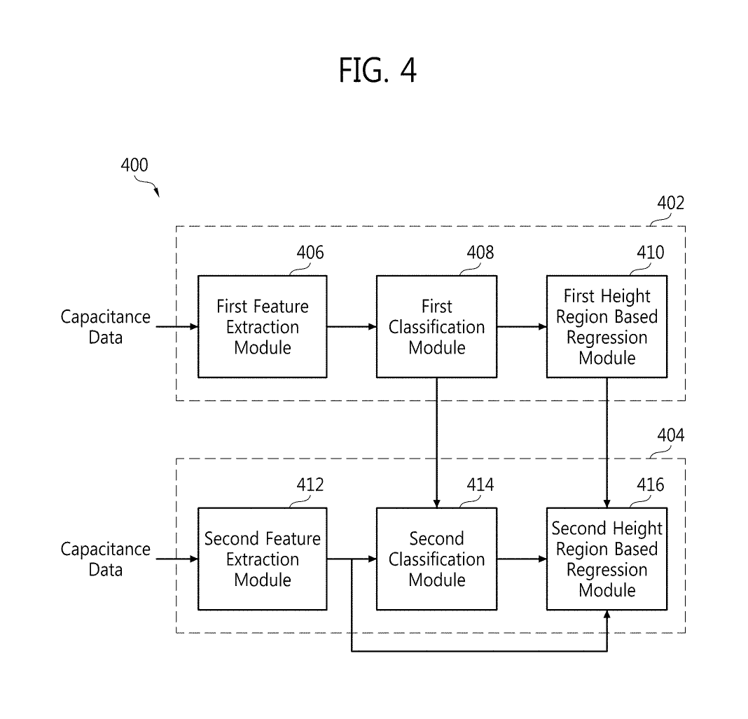

FIG. 4 is a schematic block diagram illustrating a two staged height estimation of a touch object in proximity of a capacitive touch panel, according to an exemplary embodiment. As shown in FIG. 4, the two staged height estimation includes a training phase 402 and a testing phase 404.

During the training phase 402, a capacitance data training set is received from the touch screen initially. The received capacitance data training set is provided to a first feature extraction module 406, wherein the first feature extraction module 406 extracts one or more features such as, but not limited to, an energy, a gradient, a peak, and the like from the capacitance data. Further, the extracted one or more features from the first feature extraction module 406 are then passed to a first classification module 408. The first classification module 408 identifies pre-defined classes in discrete steps, and specific pre-defined ranges. According to an exemplary embodiment, the touch screen device performs classification using at least one classification technique such as, but not limited to, linear discriminant analysis (LDA), Gaussian mixture models (GMM), and the like. The LDA and GMM based classification techniques are described in detail herein below.

Upon classifying the capacitance data in the first classification module 408, the data is then provided to a first height region based regression module 410, wherein the first height region based regression module 410 derives attributes of a regression polynomial for a fine level height calculation. In an exemplary embodiment, the estimated height of the touch object T from the touch screen P may be a three dimensional value.

During the testing phase 404, the same operations as described in the training phase, i.e., feature extraction, two staged classification, and height estimation, are performed in the online mode, wherein the touch object T is within the proximity of the touch screen P and the touch screen device can estimate a height of the touch object T from the touch screen P. During testing phase 404, the touch screen device receives the raw capacitance data from the capacitance touch sensors. The capacitance data may be provided to a second feature extraction module 412, wherein the second feature extraction module 412 extracts one or more features such as, but not limited to, an energy, a gradient, a peak, and the like from the capacitance data. Further, the extracted features from the second feature extraction module 412 may be provided to a second classification module 414. The second classification module 414 may be a model that follows an LDA or GMM based approach. The second classification module 414 receives extracted features from the second feature extraction module 412 and classes from the first classification module 408, which are learnt during training phase for both classification and regression. Based on the received extracted features and classes, the second classification module 414 may identify the classes and determine classes and ranges of the received extracted features.

Further, the data from the second classification module 414 is provided to a second height region based regression module 416, wherein the second height region based regression module 416 receives input from the second classification module 414 and input from the first height region based regression module 410 and provides an estimated height of the touch object T from the touch screen P within the proximity of the touch screen device.

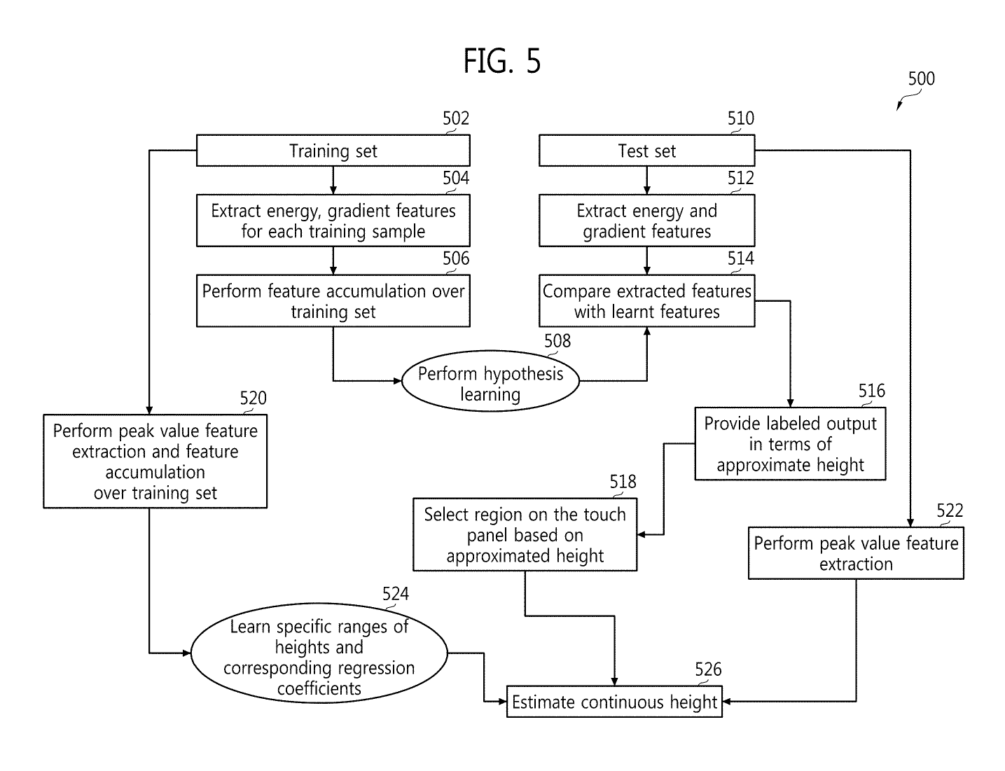

FIG. 5 is a flow chart 500 illustrating a method of performing a height estimation of a touch object within a proximity of a touch screen, according to an exemplary embodiment. According to the flow chart 500, at operation 502 a testing phase begins with a training set wherein the touch screen panel detects the touch object within the proximity of the touch screen device and thus receives capacitance data. At operation 504 the feature extraction module extracts features such as, but not limited to, energy, gradient, peak and the like for each training sample. At operation 506, the extracted features are then accumulated for the respective training set. In an exemplary embodiment, the feature energy is the summation of difference capacitance data obtained during a time in which the touch object is within the proximity of the touch screen. The feature gradient may be a summation of gradients of difference capacitance data. For instance, given a set of self-capacitance values along a width as Cx1, Cx2, Cx3, . . . , CxM and self-capacitance values along height as Cy1, Cy2, Cy3, . . . , CyN, the gradient feature can be defined as:

Gradient=|Cx¹−Cx²|+|Cx²−Cx³|+ . . . +|Cx^{M-1}−Cx^{M}|+|Cy₁−Cy²|+|Cy²−Cy³|+ . . . +|Cy^{N-1}−Cy^{N}|

Further, the feature peak may be a maximum and next to maximum values of difference capacitance data, and the feature flatness may be a ratio of geometric mean (GM) and arithmetic mean (AM) of capacitance data. However, these are only examples and alternatively other features may be extracted.

At operation 508, based on the accumulated features from operation 506, a hypothesis learning is done based on an LDA based learning model or GMM based learning model. According to an exemplary embodiment, any other known learning model may be used for hypothesis learning of the extracted features to determine a height of the touch object in discrete operations.

Further, at operation 510, testing phase begins with a test set, wherein the touch panel of the touch screen device detects the touch object within the proximity of the touch screen device. Upon detecting the touch object, the capacitance touch data is received. At operation 512, based on the received capacitance touch data, features such as, but not limited to, energy, gradient, peak and the like may be extracted. At operation 514, the data obtained from operation 508 of hypothesis learning is obtained and compared with the features extracted from the capacitance data in operation 512. Further, at operation 516, based on the comparison of the features extracted from the capacitance data in operation 512 and the data obtained from operation 508 of hypothesis learning, labeled output in terms of approximate height is determined and provided.

Further, at operation 518, a region on the touch panel (i.e., the touch screen) is selected based on the approximated height. For example, the region may be selected from the labeled output obtained from the operation 516, based on the approximate height. At operation 520, peak value feature extraction is performed and accumulated over the training set. For instance, a peak value is extracted and the peak value is accumulated over the training set. Further, at operation 522, peak value feature extraction is performed. For example, the peak value is extracted over the test set. At operation 524, based on the extracted peak value feature from operation 520, specific ranges of heights and corresponding regression coefficients are learned for the testing phase. At operation 526, the learning from operation 524, selected region from operation 518 and peak values extract in operation 522 are analyzed to estimate the continuous height.

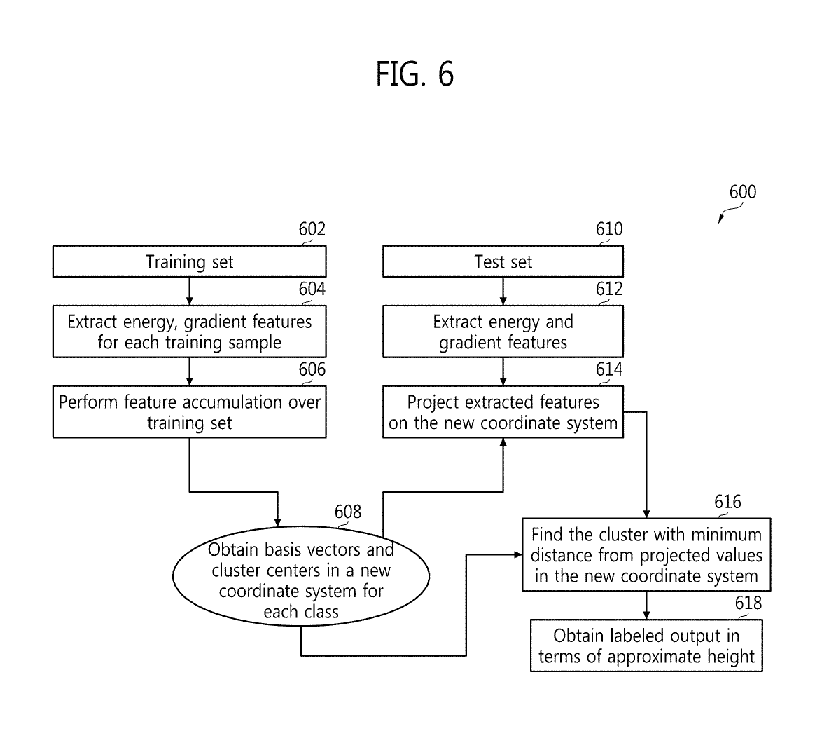

FIG. 6 is a schematic flow chart 600 illustrating a method of performing Linear Discriminant Analysis (LDA) based height estimation of a touch object from a touch panel within a proximity of a touch screen device, according to an exemplary embodiment. According to the flow chart 600, at operation 602 a testing phase begins with a training set wherein the touch screen panel detects the touch object within a proximity of the touch screen device and obtains the related capacitance touch data. The proximity may be predetermined. At operation 604, the feature extraction module extracts one or more features such as, but not limited to, an energy, a gradient, a peak and the like for each training sample. At operation 606, the extracted features are accumulated for the respective training set. Moreover, class labels for each extracted feature are accumulated, wherein the class labels include, but are not limited to, a height of the touch object from the touch panel.

Further, at operation 608, basis vectors and cluster centers in a new coordinate system are obtained for each class. For example, the LDA finds such directions from the covariance of the features, which try to maximize the inter class variance to intra class variance. In other words, the LDA tries to project existing features into new a coordinate system where features corresponding to different classes (heights) are separated very well from each other while features corresponding to a same class are clustered together. Thus, in training phase, the LDA learns basis vectors, which project data into the new coordinate system, and cluster centers in new coordinate system, one for each height class.

Further, at operation 610, testing phase begins with a test set, wherein the touch panel of the touch screen device detects the touch object within the proximity of the touch screen device. Upon detecting the touch object, the corresponding capacitance touch data is received. At operation 612, based on the received capacitance touch data, one or more features such as, but not limited to, an energy, a gradient, a peak and the like are extracted. At operation 614, the extracted features are projected on the new coordinate system. For example, the extracted features and basis vectors and cluster centers for each class obtained are analyzed together to project the extracted features onto the new coordinate system. Further at operation 616, a cluster with a minimum distance from projected values in the new coordinate system is found. For example, the basis vectors and cluster centers for each class obtained along with the newly projected coordinates for the extracted features are analyzed to find the cluster with minimum distance from the projected values in the new coordinate system. Based on the newly projected coordinates, at operation 618, a labeled output in terms of approximate height is obtained. For example, an approximate height is outputted as a labeled output.

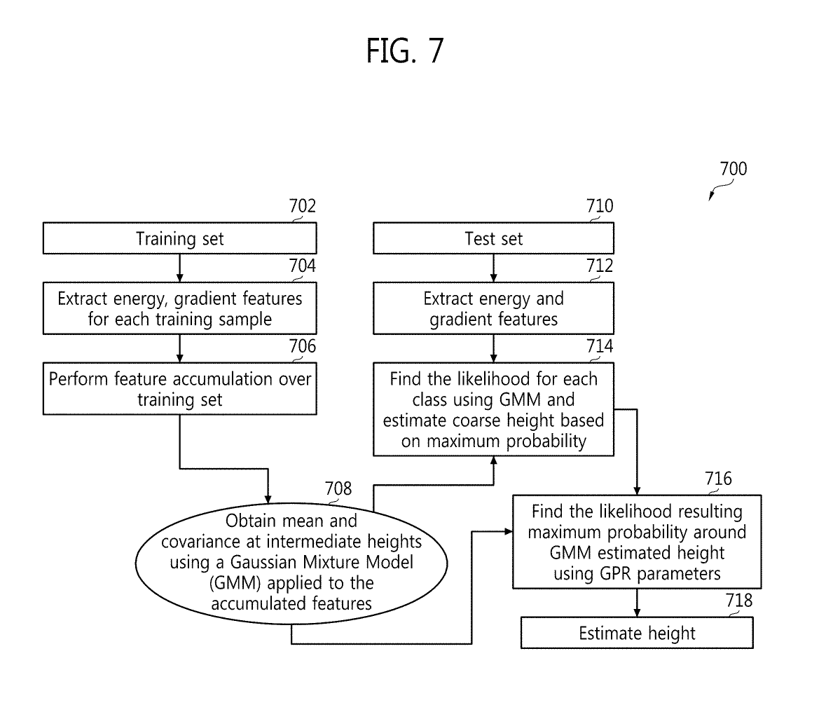

FIG. 7 is a schematic flow chart 700 illustrating a method of performing a Gaussian Mixture Model (GMM) or a Multi Gaussian Model (MGM) based height estimation of a touch object from a touch panel within the proximity of a touch screen device, according to an exemplary embodiment. According to the flow chart 700, at operation 702 a testing phase begins with a training set wherein the touch screen panel detects the touch object within a proximity of the touch screen device and thus receives capacitance touch data. At operation 704 the feature extraction module extracts one or more features such as, but not limited to, an energy, a gradient, a peak and the like for each training sample. At operation 706, the extracted features are accumulated for the respective training set. Class labels for each extracted feature are accumulated, wherein the class label includes, but is not limited, to a height of the touch object from the touch panel.

Further, at operation 708, a mean and covariance at intermediate heights are obtained by using a Gaussian Mixture Model (GMM) applied to the accumulated features. MGM or GMM is a parametric probability distribution based classifier involving two methods, a Gaussian Mixture Model (GMM) and a Gaussian Process Regression (GPR). GMM uses training data, a number of Gaussians to be involved and an initial guess about the cluster means and covariance for each Gaussian as inputs. Extracted features such as Energy and Gradient are used as training data. Since the number of Gaussians for a given height varies, estimation of the number of Gaussians for a given height is used. The number of Gaussians is estimated by finding a number of peaks in a smoothed feature distribution. Smoothing of the feature distribution is achieved through Cepstrum. Considering the feature distribution as a magnitude spectrum, the Cep strum of the feature distribution may be determined through an inverse Fourier transform of a logarithm of the feature distribution. After finding the number of peaks for a given height, K-means is applied to estimate an initial guess parameter used for the GMM. Hyper parameters for the GMM are derived through Expectation maximization. Thus, in the training phase, the GMM learns the cluster means, covariance and mixture weights at known heights. Passing the GMM results as input to the GPR, cluster means, covariance and mixture weights are obtained at intermediate heights that are unknown. Accordingly, in the training phase, MGM learns cluster means, covariance and mixture weights at known and unknown intermediate heights.

Further, at operation 710, a testing phase begins with a test set, wherein the touch panel of the touch screen device detects the touch object within the proximity of the touch screen device. Upon detecting the touch object, capacitance touch data is received. At operation 712, based on the received capacitance touch data, one or more features such as, but not limited to, an energy, a gradient, a peak and the like are extracted. Further, at operation 714, the likelihood is found for each class using the GMM and a course height is estimated based on a maximum probability. Energy and Gradient features are input to the classifier and corresponding height estimation is obtained. The coarse level height estimation is done by calculating a likelihood using training parameters obtained from the GMM (i.e., from operation 708). Further at operation 716, a likelihood resulting from the maximum probability around GMM estimated height is found using GPR parameters. A final level estimation is done by calculating a likelihood using training parameters obtained from the GPR (i.e., from operation 708). Further at operation 718, the height is estimated. The probability of a test vector falling into each cluster may be determined and the test vector with a high probability as the height may be selected as the estimated height.

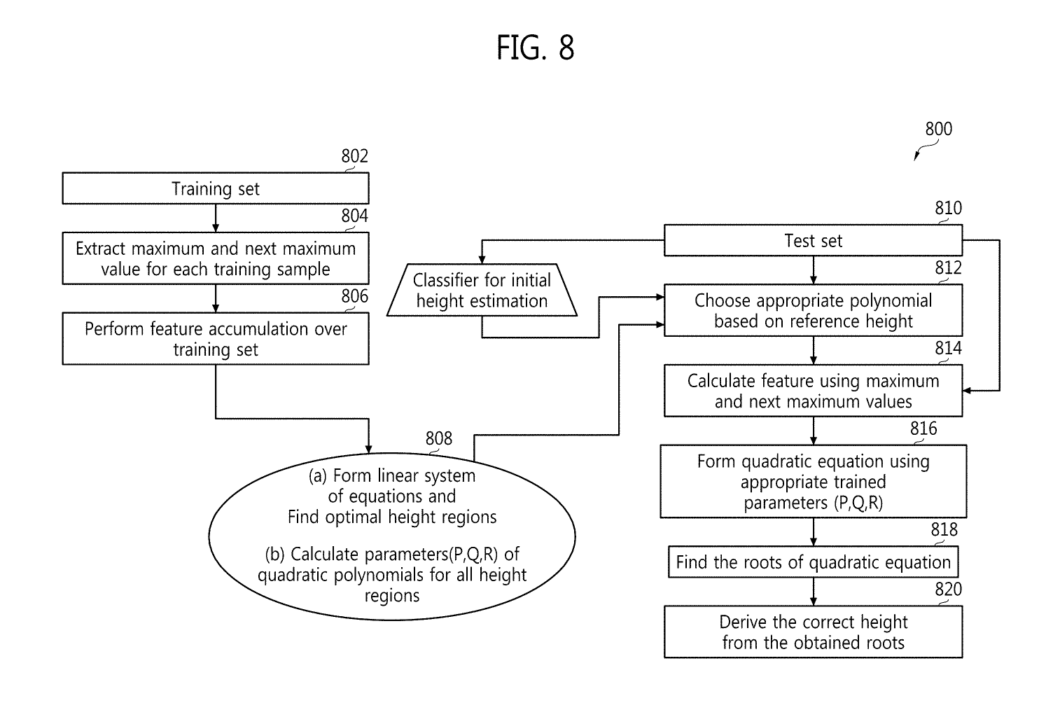

FIG. 8 is a schematic flow chart 800 illustrating a method of performing finer level height estimation based on a transfer function based regression approach, according to an exemplary embodiment. According to the flow chart 800, the height is treated as an independent variable and the feature(s) derived from capacitance data as dependent variable(s). Fitting only one polynomial for a complete height range (for example, about 1 mm to about 30 mm) results in a large height estimation error. Thus, a height range may be split into multiple height ranges and a polynomial of order N for each range may be defined. According to the present exemplary embodiment, height ranges may be overlapping or non-overlapping.

For example, in the example given above for a complete height range of 1 mm to 30 mm, overlapping height ranges may be as follows.

1 mm to 10 mm, 8 mm to 20 mm, 19 mm to 25 mm, and 23 mm to 30 mm

Alternatively, non-overlapping height ranges may be as follows:

1 mm to 10 mm, 11 mm to 20 mm, 21 mm to 25 mm and 26 mm to 30 mm

According to the flow chart 800, at operation 802 a testing phase begins with a training set wherein the touch screen panel detects the touch object within the proximity of the touch screen device and thus receives capacitance touch data. At operation 804, a maximum value and a next maximum value of the training data are extracted for each training sample collected from the received capacitance data. At operation 806, feature accumulation is performed over the training set. For example, one or more features are extracted and class labels for each extracted feature are accumulated, wherein the class label includes, but is not limited to, a height of the touch object from the touch panel.

At operation 808, a linear system of equations are formed, and optimal height regions are found. Additionally, parameters (P, Q, R) of quadratic polynomials are calculated for all height regions. For example, an optimal number of height ranges is computed based on a height estimation error and a split-merge technique. Corresponding polynomial coefficients and an order of the polynomials are stored as training parameters. In an exemplary embodiment, the polynomial coefficient are quadratic polynomials, but are not limited to this. Since the relationship between height and feature(s) is quadratic, two estimates of height values may be obtained. The appropriate height may be chosen which is close to the initially estimated height (during the classification phase). Also, few other conditions like non negativity and clipping to a maximum value (for example, 30 mm) may be imposed while choosing the correct value of height. Similarly, in the case of an ‘nth’ order polynomial, ‘n’ estimates of height may be obtained. All the above mentioned rules can be generalized accordingly. In case of overlapping regions, there may be more than one suitable polynomial for a given test case. In that case, a weighted or a simple average of estimated heights from each height region/polynomial may be taken.

At operation 810, a testing phase begins with a test set, where the touch panel of the touch screen device detects the touch object within the proximity of the touch screen device. Upon detecting the touch object, capacitance touch data is received. At operation 812, an appropriate polynomial is chosen based on a reference height. For example, based on the received capacitance touch data, a classifier for initial height estimation and appropriate polynomial coefficients are selected based on the reference height.

At operation 814, one or more features are calculated using maximum and next maximum values. For example, based on the selected appropriate polynomial and the received capacitance data, one or more features are calculated using the maximum and next maximum values. At operation 816, quadratic equations are formed using appropriate trained parameters (P,Q,R). For example, based on the calculated one or more features, a quadratic equation is formed using appropriate trained parameters. At operation 818, roots of the quadratic equation are found. Upon finding the roots of the quadratic equation, at operation 820 the correct height is derived from the obtained roots, and output.

In the following detailed description of various exemplary embodiments, reference is made to the accompanying drawings that form a part hereof, and in which are shown by way of illustration specific exemplary embodiments in which the present inventive concept may be practiced. These exemplary embodiments are described in sufficient detail to enable those skilled in the art to practice the present inventive concept, and it is to be understood that other exemplary embodiments may be utilized and that changes may be made without departing from the scope of the present claims. The following detailed description is, therefore, not to be taken in a limiting sense, and the scope is defined only by the appended claims.

What is claimed is:

1. A method for estimating location of a touch object in a capacitive touch panel, the method comprising:
receiving, by a sensing circuit, raw data for detecting a touch object in a proximity of the capacitive touch panel, the raw data comprising a difference of a mutual capacitance value and a self-capacitance value at each of a plurality of touch nodes of the capacitive touch panel;
processing, by a touch sensing controller, the received raw data to derive digitized capacitance data;
classifying, by the touch sensing controller, the digitized capacitance data; and
estimating, by the touch sensing controller, at least one of a location of the touch object on the capacitive touch panel and a distance of the touch object from the capacitive touch panel within the proximity using the classified capacitance data.

2. The method as claimed in claim 1, wherein the processing comprises:
filtering noise data from the raw data to obtain threshold digitized capacitance data; and
extracting one or more features from the threshold digitized capacitance data, the one or more features including an energy, a gradient, a peak and a flatness aspect associated with the threshold digitized capacitance data.

3. The method as claimed in claim 1, wherein the location of the touch object is estimated by determining an X coordinate and a Y coordinate of the location of the touch object on the capacitive touch panel.

4. The method as claimed in claim 1, wherein the distance of the touch object from the capacitive touch panel is estimated based on at least one of an offline mode and an online mode.

5. The method as claimed in claim 4, wherein the offline mode comprises a linear discriminant analysis (LDA) and a Gaussian mixture model (GMM).

6. The method as claimed in claim 4, wherein the online mode comprises estimating the distance of the touch object based on extracted features.

7. The method as claimed in claim 5, further comprising learning discriminant functions using extracted features, and storing cluster centers for the linear discriminant analysis (LDA) during the offline mode.

8. The method as claimed in claim 5, further comprising learning covariance matrices and mixture weights of the Gaussian Mixture Model (GMM) using extracted features obtained in the offline mode.

9. The method as claimed in claim 1, further comprising:
inputting features extracted during an offline mode to a classifier;
projecting the extracted features onto a new coordinate system using vectors obtained during an online mode;
determining distances from each of a plurality of cluster centers to the projected features in the new coordinate system; and
assigning a vector with a class label having a minimum distance from the capacitive touch panel.

10. A capacitive touch panel for estimating location of a touch object relative to the capacitive touch panel, the capacitive touch panel comprising:
a sensor circuit that receives raw capacitance data for detecting a touch object in a proximity of the capacitive touch panel, the raw data comprising a difference of a mutual capacitance value and a self-capacitance value at each of a plurality of touch nodes of the capacitive touch panel; and
at least one microprocessor configured to:
process the received raw data to derive digitized capacitance data;
extract a plurality of features from the digitized capacitance data; the plurality of features comprising an energy, a gradient and class labels;
project the extracted features on to a new coordinate system using vectors obtained during an online phase;
classify the digitized capacitance data;
determine distances from each of a plurality of cluster centers to the projected features in the new coordinate system;
assign a vector with a class label having a minimum distance from the capacitive touch panel; and
estimate at least one of a location of the touch object on the capacitive touch panel and a distance of the touch object from the capacitive touch panel within the proximity using the classified capacitance data.

11. A capacitive touch panel comprising:
a plurality of sensor electrodes configured to detect a touch object in proximity to the sensor electrodes using capacitance, and to generate raw capacitance data; and
at least one microprocessor configured to:
in a training phase, digitize training capacitance data from the sensor electrodes to generate training capacitance data, extract one or more features from the training capacitance data, classify the extracted one or more features to generate first classified data, and estimate a height of the touch object from the capacitive touch panel using the first classified data; and
in a testing phase, digitize test capacitance data from the sensor electrodes to generate test capacitance data, extract one or more features from the test capacitance data, classify the extracted one or more features based on the first classified data to generate second classified data, and determine the height of the touch object from the capacitive touch panel using the second classified data, the one or more extracted features from the test capacitance data, and the estimated height.

12. The capacitive touch panel as claimed in claim 11, further comprising an analog front end that removes noise from the raw capacitance data and digitizes the raw capacitance data.

13. The capacitive touch panel as claimed in claim 11, wherein the features comprise an energy, a gradient, a peak, and a flatness.

14. The capacitive touch panel as claimed in claim 11, wherein the extracted one or more features are classified to generate the first classified data in the training phase using a linear discriminant analysis (LDA) and/or a Gaussian mixture model (GMM), and the extracted one or more features are classified to generate the second classified data in the testing phase using a linear discriminant analysis (LDA) and/or a Gaussian mixture model (GMM).

15. The capacitive touch panel as claimed in claim 11, wherein the first classified data comprises one or more basis vectors and one or more cluster centers in a new coordinate system that is different from a coordinate system of the raw capacitance data.

16. The capacitive touch panel as claimed in claim 15, wherein in the testing phase, the one or more extracted features are projected onto a new coordinate system using the basis vectors.

17. The capacitive touch panel as claimed in claim 11, wherein the at least one microprocessor determines an X coordinate and a Y coordinate of the touch object on the capacitive touch panel.

18. The capacitive touch panel as claimed in claim 17, wherein the height is determined as a Z coordinate.
